(19) United States
(12) Patent Application Publication
(10) Pub. No.: US 2010/0289168 A1
(43) Pub. Date: Nov. 18, 2010

(54) METHOD FOR MANUFACTURING FLEXIBLE AIR-CATHODE PLATE

(76) Inventor: SUENG-NIEN KAO, Taipei (TW)

Correspondence Address: Hershkovitz & Associates, LLC, 2845 Duke Street, Alexandria, VA, 22314, US

(21) Appl. No.: 12/464,742

(22) Filed: May 12, 2009

(51) Int. Cl. H01M 4/96

(52) U.S. Cl. 264/105

(57) ABSTRACT

A manufacturing method for a flexible air-cathode plate has steps of: mixing carbon powder and polytetrafluoroethylene solution to obtain a mixture; dehydrating the mixture by centrifuge to remove excess water; pressing the mixture to form a plate having a thickness of about 0.2 to 0.3 mm; cutting the plate into at least two plates; and mounting a collector grid between two plates of at least two plates and hot pressing them to obtain the flexible air-cathode plate. Since the flexible air-cathode plate can be curved, the flexible air-cathode plate can be used for a water battery.

### BACKGROUND OF THE INVENTION

1. Field of the Invention

The present invention relates a method for manufacturing a flexible air-cathode plate, especially to be a flexible air-cathode for an air battery.

2. Description of the Prior Arts

Currently, an electrochemical battery is extensively used as a power device for many electronic products, such as but not limited to, pocket calculators, timers or transportation vehicles. The electrochemical battery has been continuously studied and improved for many years. However, due to polarization occurring during a chemical reaction, a voltage may be instable.

Instability may be solved using an air battery. The air battery has a hard air-cathode plate. The air-cathode plate allows air outside the electrochemical battery to enter the electrochemistry battery, but does not allow electrolyte to leak out. When generating electric power, the air-cathode may generate hydrogen ions, which attach to the air-cathode plate and cause polarization of the air-cathode plate. As result, an overpotential is increased while an output voltage is decreased. However, oxygen from the air passes through the air-cathode plate to form a hydronium ion with a water molecule sharing four electrons with hydrogen proton to depolarize the air-cathode plate and maintain a stable voltage.

However, since the air-cathode plate is hard, the air-cathode plate is not suitable for all applications of electrochemical batteries, especially not suitable for a circular battery. Consequently, the air-cathode has limited uses.

To overcome the shortcomings, the present invention provides a method for manufacturing a flexible air-cathode plate to mitigate or obviate the aforementioned problems.

### SUMMARY OF THE INVENTION

The main objective of the present invention is to provide a method for manufacturing a flexible air-cathode plate, especially to be an air-cathode for an air battery.

The method for manufacturing a flexible air-cathode plate in accordance with the present invention, comprises steps of: mixing carbon powder and polytetrafluoroethylene solution to obtain a mixture; dehydrating the mixture by centrifuge to remove excess water; pressing the mixture to form a plate having a thickness of about 0.2 to 0.3 mm; cutting the plate into at least two separate plates; and mounting a collector grid between two separate plates and hot pressing them to obtain the flexible air-cathode plate. Since the flexible air-cathode plate can be bent, the flexible air-cathode plate can be used for a water battery.

Other objectives, advantages and novel features of the invention will become more apparent from the following detailed description when taken in conjunction with the accompanying drawings.

### BRIEF DESCRIPTION OF THE DRAWINGS

FIG. 1 is a flow chart of a method for manufacturing a flexible air-cathode plate in accordance with the present invention;

FIG. 2 is an exploded perspective view of a flexible air-cathode plate in accordance with the present invention;

FIG. 3 is a cross sectional side view of the flexible air-cathode plate in FIG. 2;

FIG. 4 is an exploded perspective view of a water battery;

FIG. 5 is a top cross sectional top view of the water battery in FIG. 4; and

FIG. 6 is a cross sectional side view of the water battery in FIG. 4.

### DETAILED DESCRIPTION OF THE PREFERRED EMBODIMENTS

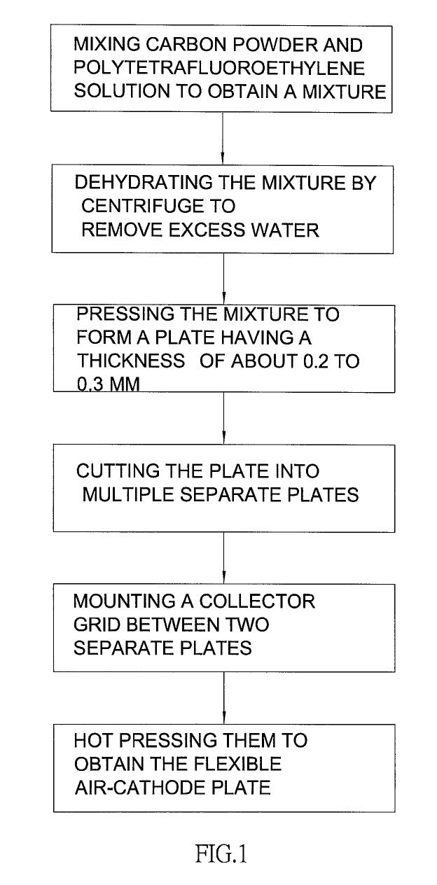

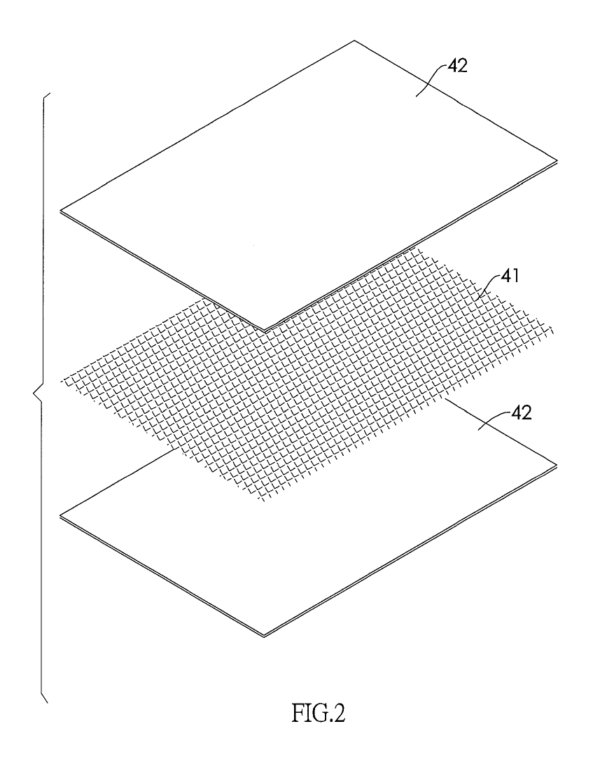

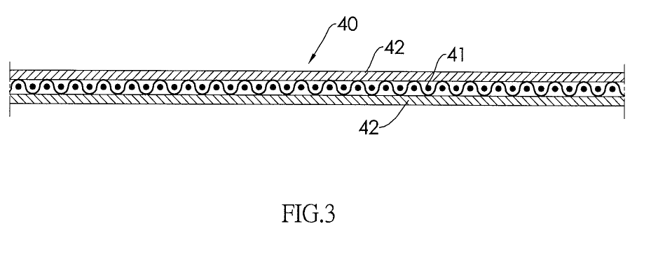

With reference to FIGS. 1 to 3, a method for manufacturing a flexible air-cathode plate in accordance with the present invention, comprises steps of: mixing carbon powder and polytetrafluoroethylene solution to obtain a mixture; dehydrating the mixture by centrifuge to remove excess water; pressing the mixture to form a plate having a thickness of about 0.2 to 0.3 mm; cutting the plate into multiple separate plates; mounting a collector grid (41) between two separate plates (42) and hot pressing them to obtain the flexible air-cathode plate (40).

Preferably, the method for manufacturing a flexible air-cathode plate further has at least one pre-treating step to extrude air from the mixture before the step of pressing the mixture. The pre-treating comprises folding and pressing the mixture.

Preferably, a weight ratio of carbon powder to polytetrafluoroethylene is 1 to 6.5.

Preferably, hot pressing is performed at between 350 and 380° C. and between 8 to 10 kg/cm³.

Preferably, the collector grid is made of copper.

### EXAMPLES

### Example 1

### Method for Manufacturing a Flexible Air-Cathode Plate

A carbon powder was mixed with a polytetrafluoroethylene solution and a weight ratio of carbon powder to polytetrafluoroethylene is 1 to 6.5. Excess water was removed from the mixture by centrifuge. Then, the mixture was folded and pressed to extrude air from the mixture. The mixture was pressed to form a plate having a thickness of 0.3 mm and the plate was cut into two separate plates. A copper grid was mounted between the two separate plates, and then pressed at 380° C. at 10 kg/cm³ to obtain a flexible air-cathode plate.

### Example 2

### Method for Manufacturing Water Battery with the Flexible Air-Cathode Plate of the Present Invention

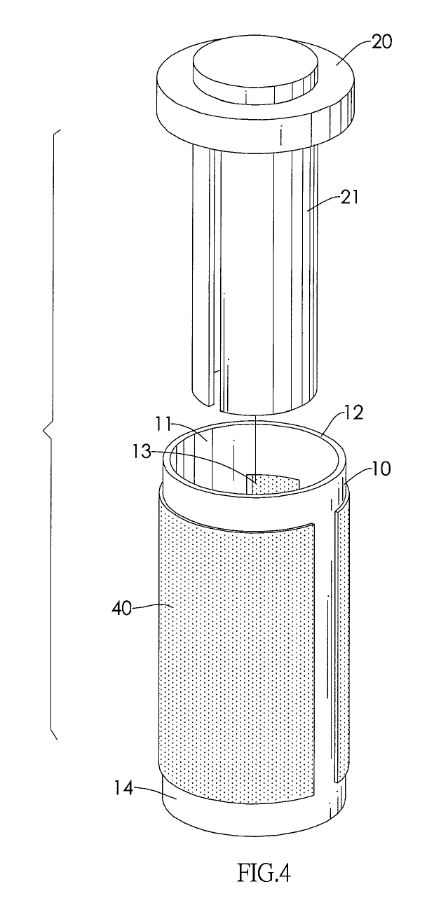

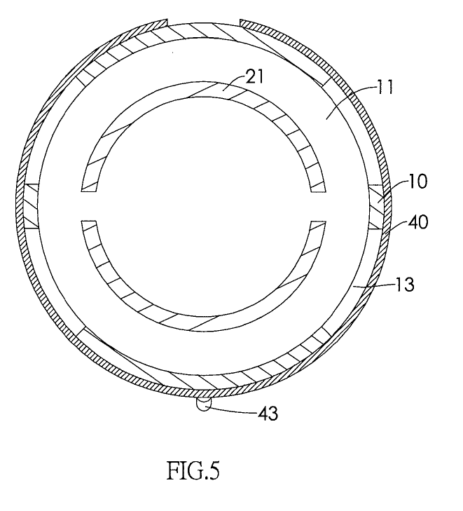

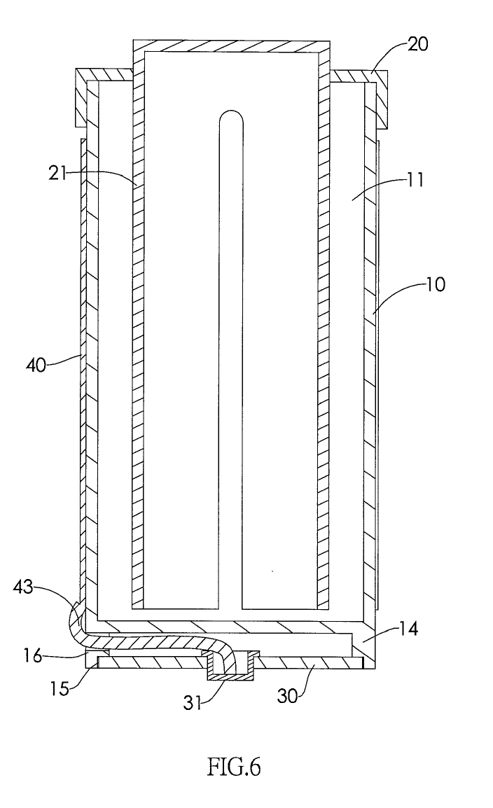

With further reference to FIGS. 4 to 6, a water battery comprises a casing (10), a top cover (20), a bottom cover (30) and a flexible air-cathode plate (40) of the present invention.

The casing (10) is a cylinder and has a top, a bottom, a sidewall, a chamber (11), a mouth (12), multiple slots (13) and an annular wall (14). The chamber (11) is formed in the casing (10). The mouth (12) is formed in the top of the casing (10) and communicates with the chamber (11). Each slot (13) is formed in the sidewall of the casing (10) and communicates with the chamber (11) of the casing (10). The annular wall (14) is formed on and extends from the sidewall at the bottom of the casing (10) and has a bottom, an opening (15) and a though hole (16). The opening (15) is formed in the bottom of the annular wall (14). The though hole (16) is formed through the annular wall (14) of the casing (10).

The top cover (20) covers the top of the casing (10) and seals the mouth (12) of the casing (10) and has an anode (21). The anode (21) is made of magnesium alloy.

The bottom cover (30) covers the opening (15) of the annular wall (14) and has an electrode cap (31).

The flexible air-cathode plate (40) is mounted around the sidewall of the casing (10) and seals each slot (13) in the sidewall of the casing (10) to seal the chamber (11) and has a wire (43). The wire (43) electrically connects each flexible air-cathode plate (40) to the electrode cap (31) of the bottom cover (30) via the though hole (16) of the annular wall (14).

When the water battery is used, the chamber (11) is filled with water serving as an electrolyte in order to electrically contact the anode (21) and the flexible air-cathode plate (40) and form a complete circuit.

Since the flexible air-cathode plate (40) can be bent, the flexible air-cathode plate (40) can be attached to various batteries.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method for manufacturing a flexible air-cathode plate comprising steps of:
mixing carbon powder and polytetrafluoroethylene solution to obtain a mixture;
dehydrating the mixture to remove excess water;
pressing the mixture to form a plate having a thickness of about 0.2 to 0.3 mm;
cutting the plate into multiple separate plates; and
mounting a collector grid between two of the multiple separate plates and hot pressing the separate plates to obtain the flexible air-cathode plate.

2. The method for manufacturing a flexible air-cathode plate as claimed in claim 1 further comprising at least one pre-treating step before the step of pressing the mixture and the pre-treating step comprises folding and pressing the mixture to extrude air from the mixture.

3. The method for manufacturing a flexible air-cathode plate as claimed in claim 1, wherein a weight ratio of carbon powder to polytetrafluoroethylene is 1 to 6.5.

4. The method for manufacturing a flexible air-cathode plate as claimed in claim 2, wherein the carbon powder and polytetrafluoroethylene are in a weight ratio of 1 to 6.5.

5. The method for manufacturing a flexible air-cathode plate as claimed in claim 1, wherein hot pressing is performed at between 350 and 380° C. at between 8 and 10 kg/cm³.

6. The method for manufacturing a flexible air-cathode plate as claimed in claim 2, wherein hot pressing is performed at between 350 and 380° C. at between 8 and 10 kg/cm³.

7. The method for manufacturing a flexible air-cathode plate as claimed in claim 3, wherein hot pressing is performed at between 350 and 380° C. at between 8 and 10 kg/cm³.

8. The method for manufacturing a flexible air-cathode plate as claimed in claim 4, wherein hot pressing is performed at between 350 and 380° C. at between 8 and 10 kg/cm³.

9. The method for manufacturing a flexible air-cathode plate as claimed in claim 1, wherein the collector grid is made of copper.

10. The method for manufacturing a flexible air-cathode plate as claimed in claim 2, wherein the collector grid is made of copper.

11. The method for manufacturing a flexible air-cathode plate as claimed in claim 3, wherein the collector grid is made of copper.

12. The method for manufacturing a flexible air-cathode plate as claimed in claim 4, wherein the collector grid is made of copper.

13. The method for manufacturing a flexible air-cathode plate as claimed in claim 5, wherein the collector grid is made of copper.

14. The method for manufacturing a flexible air-cathode plate as claimed in claim 6, wherein the collector grid is made of copper.

15. The method for manufacturing a flexible air-cathode plate as claimed in claim 7, wherein the collector grid is made of copper.

16. The method for manufacturing a flexible air-cathode plate as claimed in claim 8, wherein the collector grid is made of copper.

17. The method for manufacturing a flexible air-cathode plate as claimed in claim 1, wherein dehydrating the mixture comprises dehydrating the mixture by centrifuge to remove excess water.
